(19) United States
(12) Patent Application Publication
(10) Pub. No.: US 2006/0119004 A1
(43) Pub. Date: Jun. 8, 2006

(54) Method and apparatus for reforming the neck finish end surface of blow molded plastic container

(75) Inventors: Dave Chmura, Perrysburg, OH (US); Brian J. Chisholm, Toledo, OH (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 11/001,137

(22) Filed: Dec. 2, 2004

(51) Int. Cl. B29C 57/00

(52) U.S. Cl. 264/322; 425/525

(57) ABSTRACT

A method of reforming the end portion and sealing surface of a blow molded plastic container includes directing energy from a non-contact heater onto the annular end portion of the container neck finish so as to heat the end surface to its softening temperature while leaving the remainder of the neck finish relatively unheated. The heated annular end portion of the neck finish is then engaged by an unheated forming tool so as to reform and cool the end sealing surface of the neck finish. Heating and reforming the neck finish end portion in separate steps allows the heating step to be controlled either by intensity of the heat source or dwell time of the container adjacent to the heater. Employing an unheated forming tool reduces the tendency of the container neck finish to stick to the tool.

The present invention relates to blow molded plastic containers, particularly extrusion blow molded plastic containers, and more particularly to reforming the end surface of the container neck finish after molding and trimming.

### BACKGROUND AND SUMMARY OF THE INVENTION

Extrusion blow molding plastic containers involves extruding a tube of monolayer or multilayer plastic material, capturing the tube between opposed mold sections, blowing the tube to the contours of the mold cavity, opening the mold, removing the container, and trimming the end of the container neck finish. This trimming operation can involve removal of a dome or moil from the neck finish, which is a convenience element for the blow molding operation and can be recycled as process regrind. In another type of extrusion blow molding operation, the trimming operation can involve separation of two containers that are molded end-to-end. In either event, the trimming operation can leave an uneven end surface for later sealing engagement with a container closure. Furthermore, the end surface of the container neck finish may have mold parting line seams that can deleteriously affect sealing engagement with a container closure. It typically is necessary to induction weld a liner disk to the container end surface after filling the container to obtain a satisfactory container seal.

It has been proposed to reform the end surface of the neck finish by contacting the neck finish end surface with a heated forming tool. This tool simultaneously heats the end portion of the neck finish to the softening temperature of the plastic material, and reforms the end surface in an effort to eliminate mold parting line seams, trim scars and other post-molding scars. However, the container neck finish tends to stick to the hot forming tool. It is also difficult to control the temperature of the forming tool so as to obtain a desired temperature at the forming surface of the tool. Furthermore, the combination of the tendency of the container to stick to the forming tool and the difficulty of controlling the forming surface temperature of the tool makes the tool/container contact time process window very narrow and difficult to control. The dwell time, during which the forming tool is in contact with the end portion of the neck finish, should be minimized to achieve desired production speeds. It is a general object of the present invention to provide a method and apparatus for reforming a container neck finish end surface after molding to prepare the end surface for enhanced sealing engagement with a closure, which overcome some or all of the problems and difficulties previously discussed. Another general object of the present invention is to provide a container having a neck finish end sealing surface reformed employing the method and/or the apparatus of the present invention.

A method of reforming the end portion and sealing surface of a blow molded plastic container in accordance with one aspect of the present invention includes directing energy from a non-contact heater onto the annular end portion of the container neck finish so as to heat the end surface to its softening temperature while leaving the remainder of the neck finish relatively unheated. The heated annular end portion of the neck finish is then engaged by an unheated forming tool so as to reform and cool the end sealing surface of the neck finish. Heating and reforming the neck finish end portion in separate steps allows the heating step to be controlled by the intensity of the heat source and/or the dwell time of the container adjacent to the heater. Employing an unheated forming tool reduces the tendency of the container neck finish to stick to the tool. The container neck finish can be heated with additional or more powerful non-contact heaters while not affecting the dwell time in contact with the forming tool, thereby giving a greater level of process control.

An apparatus for reforming an end portion and sealing surface of a blow molded plastic container in accordance with another aspect of the present invention includes a non-contact heater for focusing radiant heat energy onto a container neck finish end portion to heat at least an end surface of the end portion to the softening temperature of the plastic material while leaving the remainder of the neck finish relatively unheated. An unheated forming tool is provided to contact, reform and cool the end portion of the container finish after heating by the heater. The unheated forming tool preferably has a surface for engagement with the heated end portion of the container neck finish. In two preferred embodiments of the invention, the unheated forming tool has a portion for opposed abutment with a shoulder on the unheated portion of the container neck finish or with tooling that engages the container neck finish to limit engagement of the reforming tool with the neck finish.

A plastic container in accordance with a further aspect of the present invention has a blow molded and trimmed neck finish with an axially facing end surface that is free of mold parting line seams, trim scars and other post-mold scars. In preferred embodiments in accordance with this aspect of the invention, the blow molded and trimmed neck finish has a radially inwardly extending end flange, with the end flange having an external surface forming the axially facing end surface of the neck finish. In accordance with yet another aspect of the invention, the neck finish has an end surface, preferably planar, and a flange, preferably circumferentially continuous, that extends radially inwardly and axially downwardly from the neck finish end surface.

### BRIEF DESCRIPTION OF THE DRAWINGS

The invention, together with additional objects, features , advantages and aspects thereof, will be best understood from the following description, the appended claims and the accompanying drawings, in which:

FIG. 1 is a schematic diagram that illustrates non-contact heating of the end portion of a container neck finish in accordance with one presently preferred aspect of the invention;

FIG. 2 is a schematic diagram that illustrates contacting the heated container neck finish end portion with a forming tool in accordance with one embodiment of the present invention;

FIG. 3 is an enlarged fragmentary view of the portion of FIG. 2 within the area 3;

FIG. 4 is a fragmentary schematic diagram that illustrates a container neck finish end portion and forming tool in accordance with a second embodiment of the invention;

FIG. 5 is a fragmentary sectional view on an enlarged scale of the portion of FIG. 4 within the area 5;

FIGS. 6 and 7 are sequential schematic diagrams similar to that of FIG. 5 but showing sequential steps in accordance with the method of the present invention;

FIG. 8 is a schematic diagram of a further embodiment of the invention;

FIG. 9 is a fragmentary view on an enlarged scale of the portion of FIG. 8 within the area 9;

FIG. 10 is a fragmentary sectional view of a container neck finish reformed in accordance with one aspect of the present invention; and

FIGS. 11 and 12 are fragmentary sectional views showing a further embodiment of the forming head in accordance with the present invention.

### DETAILED DESCRIPTION OF PREFERRED EMBODIMENTS

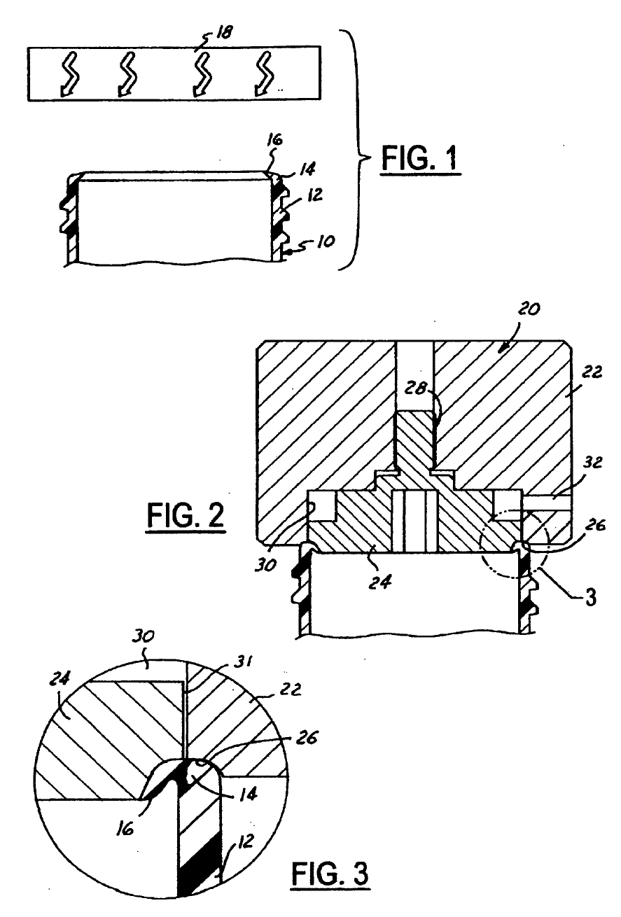

FIGS. 1-3 illustrate a method and apparatus for reforming the end sealing surface of a plastic container neck finish in accordance with one presently preferred embodiment of the invention. Referring to FIG. 1, a plastic container 10 has a neck finish 12 with an end portion 14 that includes a radially inwardly and axially upwardly extending flange 16. (Directional words such as “upwardly” and “downwardly” are employed by way of description and not limitation with respect to the orientation of the apparatus and the containers illustrated in the drawings. Directional words such as “axial” and “radial” are employed by way of description and not limitation with respect to the axis of the container finish or the reforming tool as appropriate.) Flange 16 typically is formed by a trimming operation after extrusion blow molding, for example, in which container 10 is severed from a moil or the like. Flange 16 as initially formed has a radially outwardly and axially upwardly facing surface that typically forms the end sealing surface of the neck finish.

Neck finish 12 of container 10 is positioned adjacent to a non-contact heater 18. By “non-contact” is meant that the heating energy is transferred to neck finish 12 by radiation, and not by physical contact with the neck finish. Heater 18 may comprise an infrared heater, a quartz lamp, a focused light or the like. Heater 18 preferably is constructed to focus the heating energy onto the neck finish end portion 14 so as to heat at least the end surface of flange 16 to the softening temperature of the plastic material while leaving the remainder of neck finish 12 substantially unheated. That is, the end portion of the neck finish, comprising at least the end surface, is heated to its softening temperature, while the remainder of the neck finish (and indeed the remainder of the container) is substantially unheated by heater 18.

After heating neck finish end portion 14, a forming tool head 20 is brought into contact with the end portion of the container neck finish, as shown FIGS. 2 and 3. Forming tool head 20, which is unheated, preferably includes a shell 22 having a central plug 24 removably received therein. Adjacent end portions of shell 22 and plug 24 form an annular channel 26 for opposed facing engagement with finish end portion 14. That is, after heating finish end portion 14 to its softening temperature, unheated forming tool head 22 is brought into contact with the container neck finish so that heated end portion 14 is engaged under pressure by the opposing surface of channel 26. The neck finish end portion thereby is reformed, cooled and solidified by the opposing surface of channel 26 so as to form a smooth neck finish end surface for sealing engagement with a closure or the like. Plug 24 is threadably received within shell 22 in this embodiment so that the adjacent portions of channel 26 can be brought into alignment without having a shoulder or step in the channel surface between the plug and shell. This threaded engagement is illustrated at 28 in FIG. 2. Plug 24 and shell 22 preferably are such that a small radial gap 31 extends from channel 26 to pocket 30. This gap 31 preferably is annular and of substantially uniform radial width, such as on the order of 0.001 inch. Gap 31 allows air to vent from the contact area of channel 26. Gap 31 also functions as a thermal barrier between plug 24 and chuck 22. Pocket 30 preferably is connected to the external atmosphere by one or more passages 32 to minimize heating of plug 26 and chuck 22 due to contact with the container neck finishes during reforming, and to vent the air from gap 31.

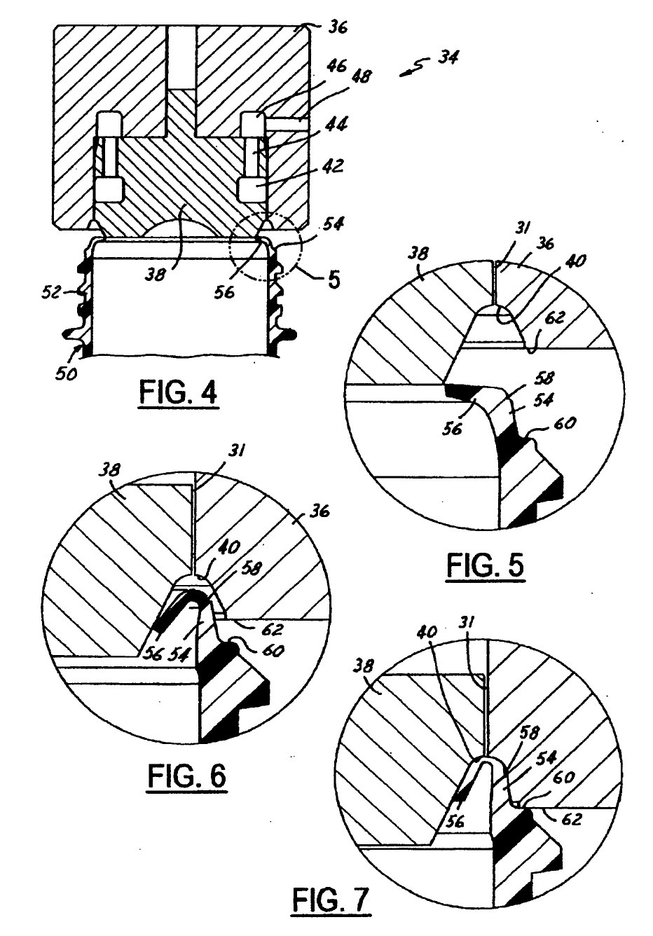

FIGS. 1 and 4-7 illustrate a reforming apparatus and process in accordance with a second embodiment of the invention. In FIGS. 4-7, the forming tool head 34 includes a shell 36 and a plug 38. Shell 36 and plug 38 have opposed channel segments that together form a annular channel 40 for engaging and reforming the container neck finish end portion, as in the previous embodiment. Plug 38 again is positionable within shell 36 in this embodiment to bring the adjacent channel segments into smooth alignment, and air channels and passages 42, 44, 46, 48 are provided in plug 38 and shell 36 to minimize heating of the surfaces that form forming channel 40. An air vent gap 31, preferably annular, circumferentially continuous and of substantially uniform radial dimension, again is formed between the outer periphery of plug 38 and the opposing surface of shell 36, both of which preferably are cylindrical.

The container 50 illustrated in FIGS. 4-7 has a neck finish 52 with an end portion 54 and a flange 56 in accordance with another aspect of the invention. That is, as best seen in FIG. 5, flange 56 has an external groove 58 that extends circumferentially around the flange, at about the mid portion of the flange, in a plane perpendicular to the axis of the neck finish. The purpose of groove 58 is to localize bending of flange 56 during the reforming operation to the end portion of the flange, as shown in FIG. 7. Neck finish end portion 54 also has an axially facing shoulder 60 in the embodiment of FIGS. 4-7. This axially facing external shoulder 60 cooperates with an opposed axially facing shoulder 62 on shell 36 to limit axial motion of toot 34 and container neck finish 52 with respect to each other, as shown in FIG. 7, and thereby to limit and control bending of flange 56 and to maintain dimensional tolerance stability during the reforming operation. Neck finish shoulder 60 preferably is spaced sufficiently from flange 56 so as not to be heated substantially by the focused energy from heater 18 (FIG. 1), so that contact by tool shoulder 62 does not reform shoulder 60.

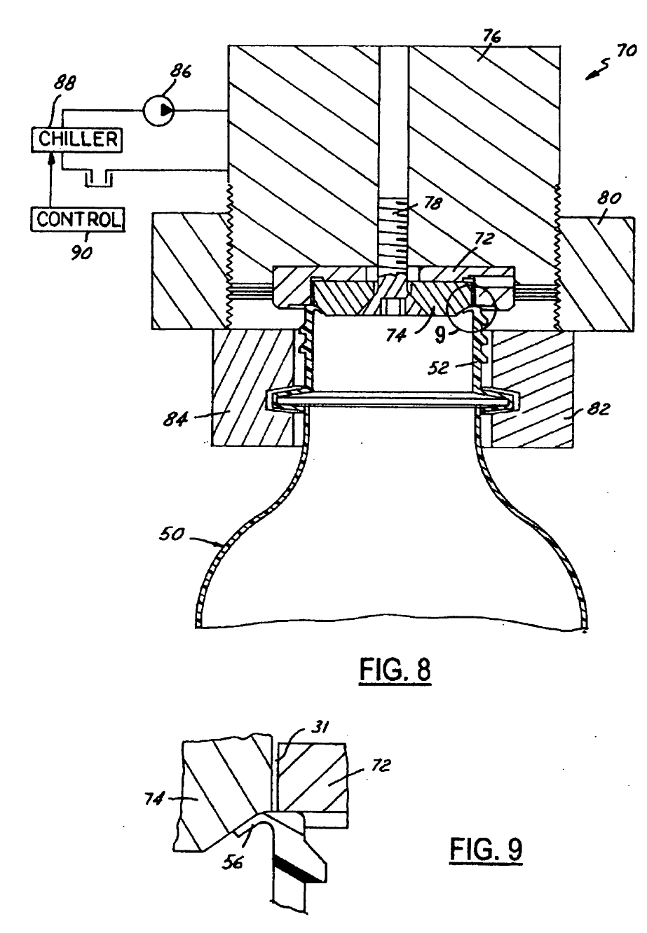

FIGS. 8 and 9 illustrate a reforming tool head 70 in accordance with another embodiment of the invention. Head 70 includes a shell 72 and a plug 74 that are mounted to a holder 76 by a screw 78. An air vent gap 31 again is formed between the outer periphery of plug 74 and the opposing surface of shell 72. A collar 80 is adjustably threadably received on holder 76. Collar 80 preferably is adjusted on holder 76 to abut a pair of clamp arms 82, 84 that hold container 50 in position beneath head 70. Thus, collar 80 cooperates with clamp arms 82, 84 to limit and control the bending of flange 56, but without contacting a shoulder on container finish 52 as in the embodiment of FIGS. 4-7. FIG. 8 also illustrates cooling of head 70 by means of a pump 86 that circulates a coolant, such as a water/glycol mixture, through a chiller 88. Chiller 88 has an associated control 90 for setting a desired coolant temperature.

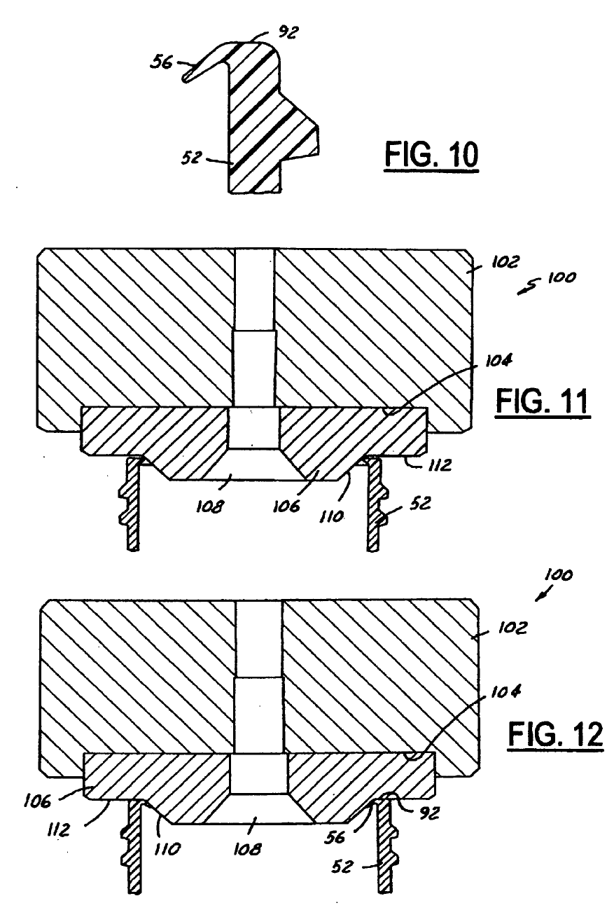

FIGS. 11-12 illustrate a reforming tool head 100 in accordance with a further embodiment of the invention. A shell 102 has a pocket 104 within which a plug 106 in mounted by a screw 108. Plug 106 has a conical surface 110 and a peripheral flat surface 112 that faces the neck finish of the container. When head 100 is brought into engagement with the container neck finish (FIG. 12), the flange 56 is engaged by the conical surface 110 to reform the flange axially inwardly. The end surface 92 is engaged by the flat surface 112.

In the four illustrated embodiments of the invention (FIGS. 1-3, FIGS. 1 and 4-7, FIGS. 1 and 8-9, and FIGS. 1 and 11-12), the neck finish end portion is first subjected to focused non-contact heating so as to heat at least the end surface of the neck finish end portion to its softening temperature while leaving the remainder of the neck finish substantially unheated. The neck finish end portion is then engaged by an unheated forming tool so as to reform the heated and softened end portion of the neck finish. As noted above, the heating operation can be accomplished using various techniques, including an infrared lamp, radiant heater, quartz lamp, focused light energy, etc. The unheated forming tool may be at room temperature (ignoring the heating effects due to contact with the heated neck finish end portion), or may be cooled by circulation of a coolant fluid such as air or another media. The pressure applied by the forming tool and the reforming tool contact time may be adjusted empirically to obtain the desired end surface reformation at the container neck finish end portion. The neck finish end portion takes the shape of the opposing surface(s) of the forming tool, which leaves the neck finish end surface free of features that can deleteriously affect the ability to seal against the neck finish end surface, such as mold parting line mismatch seams, nicks and other features created in the production and trimming process. The neck finish 52 in FIG. 10 has an end surface that preferably is planar, and a flange 56 (or 16 in FIGS. 1-3) that extend radially inwardly and axially downwardly from the end surface. Flange 56 preferably is circumferentially continuous.

The container of the present invention can be of monolayer plastic construction, or can be of multilayer plastic construction in which intermediate layers may or may not extend into the neck finish end portion of the container. At least the end surface of the container neck finish end portion is heated to a temperature at which the plastic is soft and suitable for reforming. For polypropylene, it has been found that the reforming temperature can be in the range of about 220 to 320\F, more preferably about 275 to 315\F, and most preferably about 300\F. The forming surface of the unheated reforming tool is maintained at a temperature of not more than about 100\F. In an implementation of the embodiment of FIGS. 8-9, chiller 88 is controlled to maintain a temperature of about 60\F at reforming head 70. The heated neck finish is engaged by the reforming tool preferably about three seconds or less after heating.

There have thus been disclosed an apparatus and method for reforming a container neck finish end surface, and a container having a reformed neck finish end surface, that fully satisfy all of the objects and aims previously set forth. The invention has been disclosed in conjunction with three presently preferred embodiments thereof, and a number of modifications and variations have been discussed. Other modifications and variations will readily suggest themselves to persons of ordinary skill in the art. Although the invention has been disclosed in conjunction with reforming the trimmed end of an extrusion blow molded container neck finish, the invention in its broadest aspects can be applied to other types of container neck finishes. For example, the invention in its broadest aspects can be implemented in conjunction with injection or compression molded neck finishes on containers made in a reheat blow molding operation or an injection/extrusion/blow molding operation. The invention is intended to embrace these and all other modifications and variations that fall within the spirit and broad scope of the appended claims.

1. A method of reforming the end portion and sealing surface of a blow molded plastic container, which includes the steps of:
(a) directing energy from a non-contact heater onto an annular end portion of a container neck finish so as to heat said end portion to its softening temperature while leaving the remainder of said neck finish relatively unheated, and then
(b) engaging said annular end portion with an unheated forming tool so as to reform and cool the end sealing surface of the neck finish.

2. The method set forth in claim 1 wherein said step (b) includes the step of:
(c) limiting engagement of said forming tool with said annular portion of said neck finish.

3. The method set forth in claim 2 wherein said step (b) includes engaging the container neck finish with tooling to hold said neck finish in position with respect to said forming tool, and wherein said step (c) is carried out by engaging a portion of said forming tool against said tooling.

4. The method set forth in claim 2 wherein said neck finish has an annular shoulder at a position spaced from said end portion, wherein said unheated forming tool has a shoulder in opposition to said shoulder on said neck finish, and wherein said step (c) is carried out by moving said unheated forming tool against said end portion until said shoulder on said forming tool engages said shoulder on said neck finish.

5. The method set forth in claim 1 wherein said end portion of said neck finish includes a radially inwardly extending flange, said step (a) includes heating an outer surface portion of said flange to its softening temperature, and said step (b) includes bending said flange radially and axially inwardly by engagement with said forming tool.

6. The method set forth in claim 5 wherein said flange has an external groove to localize bending of said flange during said step (b) to an end portion of said flange.

7. A blow molded plastic container having a neck finish and an end portion reformed in accordance with the method set forth in claim 1.

8. A plastic container having a blow molded and trimmed neck finish with an axially facing end surface that is free of mold parting line seams and trim scars.

9. The container set forth in claim 8 wherein said blow molded and trimmed neck finish has a radially inwardly extending end flange, said end flange having an external surface forming said axially facing end surface.

10. The container set forth in claim 9 wherein said flange has an external groove extending circumferentially around said flange in a plane perpendicular to an axis of said neck finish.

11. Apparatus for reforming an end portion and sealing surface of a blow molded plastic container, which includes:
a non-contact heater for focusing radiant heat energy onto a container neck finish end portion to heat at least an end surface of the container neck finish end portion to its softening temperature while leaving the remainder of the neck finish relatively unheated, and
an unheated forming tool separate from said heater to contact, reform and cool the end portion of the container neck finish after heating by said heater.

12. The apparatus set forth in claim 11 wherein said forming tool includes a shell having a pocket and a plug received in said pocket.

13. The apparatus set forth in claim 12 wherein adjacent portions of said plug and said shell form a surface for engagement with the end portion of the container neck finish.

14. The apparatus set forth in claim 13 wherein said forming tool includes an air gap between said plug and said shell, said air gap extending from said forming surface to said pocket to vent air from between said forming surface and the end portion of the neck finish.

15. The apparatus set forth in claim 11 wherein said forming tool includes a head having a forming surface for engagement with the container neck finish.

16. The apparatus set forth in claim 15 wherein said head includes at least one air vent passage extending from said forming surface to vent air from between said forming surface and the end portion of the container neck finish.

17. The apparatus set forth in claim 15 including a cooler coupled to said head for cooling said head.

18. The apparatus set forth in claim 17 wherein said cooler includes means for circulating liquid coolant through said head.

19. The apparatus set forth in claim 15 wherein said head has an annular channel for receipt over the heated end portion of the container neck finish.

20. The apparatus set forth in claim 15 wherein said head includes means for limiting engagement with the end portion of the container neck finish.

21. The apparatus set forth in claim 20 wherein said means includes a collar that is adjustably positionable on said head for abutment with tooling for holding the container in position with respect to said head.

22. The apparatus set forth in claim 20 wherein said means includes a shoulder for opposed abutment with a shoulder on the container neck finish to limit engagement of said forming tool with the neck finish end portion.

23. A container having a neck finish of molded plastic construction, said neck finish having an end surface and a flange extending radially inwardly and axially downwardly from said end surface.

24. The container set forth in claim 23 wherein said end surface is planar, and said flange is circumferentially continuous.
